(19) United States
(12) Patent Application Publication
(10) Pub. No.: US 2003/0076099 A1
(43) Pub. Date: Apr. 24, 2003

(54) Reduced signal to noise ratio array coil image

(76) Inventors: Joseph V. Hajnal, London (GB); Mark Bydder, London (GB); David J. Larkman, London (GB)

Correspondence Address: THOMAS M. LUNDIN, Philips Medical Systems (Cleveland), Inc., 595 Miner Road, Cleveland, OH, 44143, US

(21) Appl. No.: 10/126,217

(22) Filed: Apr. 19, 2002

(30) Foreign Application Priority Data
Apr. 20, 2001 (GB) 0109793.0
May 22, 2001 (GB) 0112508.7
Sep. 7, 2001 (GB) 0121744.7

(51) Int. Cl. G01V 3/00

(52) U.S. Cl. 324/307; 324/309

(57) ABSTRACT

Better signal-to-noise ratio is obtained when combining the images from an array coil used in magnetic resonance imaging apparatus by using the relative sensitivity of each coil obtained by division of the images from each coil on a pixel-by-pixel basis.

### BACKGROUND

This invention relates to magnetic resonance (MR) imaging.

A prior art magnetic resonance imaging apparatus is shown in FIG. 1. A patient supported on a bed 1 is slid axially into the bore 2 of a superconducting magnet 3, and the main magnetic field is set up along the axis of the bore, termed by convention the Z-direction. Magnetic field gradients are set up, for example, in the Y-direction, to confine the excitation of magnetic resonant (MR) active nuclei (typically hydrogen protons in water and fat tissue) to a particular horizontal slice in the Y-direction and, in the horizontal X and the Z-directions as seen in FIG. 1, to encode the resonant MR nuclei in the plane of the slice. An r.f. transmit coil (not shown) applies an excitation pulse to excite the protons to resonance, and an r.f. receive coil array consisting of an array of coils 4 picks up relaxation signals emitted by the disturbed protons.

The array of coils 4 could be a spine array such as is illustrated in FIGS. 2 (plan) and 3 (side view). The array is made of four coils C₁-C₄ in the example shown in FIG. 2, but normally more would be provided. To help visualise the imaging process, a circle 5 and square 6 in the plane of the imaged slice are shown superimposed over the array. The circle could correspond with the location of the head of a patient and the square could correspond with the location of the feet.

To encode/decode received signals in the Z-direction, the signals are detected in the presence of a magnetic field gradient, termed a frequency encode or read-out (R.O.) gradient, to enable different positions of relaxing nuclei to correspond to different precession frequencies of those nuclei about the direction of the main magnetic field due to the influence of the gradient. The data is digitised, and so for each r.f. excitation pulse, a series of digital data points are collected, and these are mapped into a spatial frequency domain known as k-space (FIG. 4). Each r.f. pulse permits at least one row of digital data points to be collected. A spatial frequency domain matrix is built up for each of the individual coils C₁-C₄ of the array from the data collected.

To encode/decode the received signals in the X-direction, after each r.f. pulse has been transmitted and before data is collected with the read-out gradient applied, a magnetic field gradient in the X-direction is turned on and off. This is done for a series of magnitudes of magnetic field gradients in the X-direction, one r.f. pulse typically corresponding to a different magnitude of gradient in the X-direction. The series of measurements enable spatial frequencies to be built up in the X-direction.

The slices to be imaged need not be in the X-Z plane, however, other parallel, orthogonal or oblique planes may be imaged.

On the k-space matrices shown in FIG. 4, the different rows of data points correspond to data collected at different magnitudes of phase-encode (P.E.) gradients.

Conventionally, the k-space data collected by each receive coil C₁-C₄ is subject to a two dimensional fast Fourier Transform in a Fourier Transform processor (not shown) to produce a respective pixelated spatial image (FIG. 5). The spatial images are then combined on a pixel-by-pixel basis to form a resultant image. For example, each of the spatial images could be 256 by 256 pixels. Thus, for example, to produce the resultant intensity of pixel p in the final image, the value of the intensity of the pixel in the same co-ordinate position in each of the intensity images is combined.

It has been pointed out (Roemer P B, Edelstein W A, Hayes C E, Souza S P, Mueller O M—The NMR Phased Array, Magnetic Resonance in Medicine 16, 192-225 (1990) that the optimal array coil performance is achieved by coherently adding on a pixel-by-pixel basis the intensities Sᵢ with each weighted by the sensitivity of the coil bᵢ at the pixel location. Optimal signal-to-noise ratio is obtained from the sum

$$P = \frac{1}{{\sum }_{J} {b}_{j}^{2}} {\sum }_{1} {S}_{i} {b}_{i}^{*}$$

over all coils₁, where P is the resultant intensity of each pixel of the combined image, and bⱼ* is the complex conjugate of bᵢ. The denominator represents a normalisation factor.

A flow chart shows the method (apart from the normalisation) in more detail in FIG. 6. Box 7a (S₁) indicates data representing the intensity of each pixel in complex form derived from coil 1. Box 7b (b₁) indicates data representing the sensitivity of coil 1 for each pixel, again in complex form. Box 7c (Sᵢbᵢ*) indicates the calculating, for each pixel, of the product S₁bᵢ*. Boxes 8a-10a, 8b-10b, 8c-10c represent similar functions in relation to coils C₂-C₄. The products, from the four receive coils C₁-C₄, are then added (11) to produce the final image (12). It is usual to take the magnitude for the final image since the data is in complex form and, while the final data has no phase variation due to coil effects, there may be phase variations due to other instrumental or physical processes.

Roemer noted that in most practical circumstances bᵢ is not known at each pixel location but that, provided that Sᵢ is much greater than the background noise, a good approximation is achieved by replacing bᵢ with Sᵢ so that

P=√[ΣSᵢ²]

Referring to FIG. 7, for each coil C₁-C₄, the intensity of each pixel of the high resolution spatial image (7a, 8a, 9a, 10a) is squared (7d, 8d, 9d, 10d). Since the intensity data is in complex form, this means taking the product of each complex intensity value and its complex conjugate. Thus, if S=a+ib, the complex conjugate S*=a−ib. Again, to produce each pixel of the final image, the product for each pixel is summed over all the coils (11), and the square root taken (13) to produce the final image (12).

This method, known as the sum of squares method, well in strong signal regions, but incurs a noise penalty. This is because coils of the array which for one reason or another do not contribute any signal at all still contribute noise, which would be included in the overall sum. However, this formulation is the standard one in use.

Recently, various techniques have been developed which aim to reduce the time a patient has to spend in an imaging apparatus to collect sufficient data to acquire a satisfactory image. One way of doing this is to acquire less than a full set of phase-encode gradients. Of course, to do this on its own would just result in an aliased image. What is therefore done is to image the region of interest using an array of coils, so-called parallel imaging, and to unfold the aliased image using a knowledge of the spatial sensitivities of the coils (Magnetic Resonance in Medicine 42: 952-962 (1999)—SENSE: Sensitivity Encoding For Fast MRI by Klaas P Pruessmann, Markus Weiger, Markus B Scheidegger and Peter Boesiger).

In the case of an array of just two coils, one arranged on each side of a region to be imaged, it is sufficient to obtain the ratio of the response of one coil to the other, in order to obtain the spatial sensitivity of each coil to perform the unfolding.

This ratio must be obtained when an object, for example, the object to be imaged, or a phantom, is within the sensitive volume.

It is desirable to carry out post-processing to reduce noise in the ratio of the sensitivities. However, care has to be taken to prevent sharp edges in the ratio which result from features in the object itself, also being smoothed.

It was to overcome this problem that the Applicants proposed collecting sensitivity information at reduced resolution compared to that at which the image was collected (EP-A-1 102 076). The sensitivity of one coil relative to another varies fairly smoothly, and is accurately represented even at reduced resolution. Undesirable sharp variations in the relative sensitivity resulting from the object being imaged are smoothed.

### SUMMARY

The invention provides magnetic resonance imaging apparatus comprising means for exciting magnetic resonant (MR) active nuclei in a region of interest, means for creating magnetic field gradients in a phase-encode direction for spatially encoding the excited MR active nuclei, the number of phase-encode gradients producing a field of view corresponding to the region of interest, an array of at least two r.f. receive coils for receiving data from the region of interest, and means for producing an image by combining signals from the coils of the array, using the relative sensitivity of each coil.

The use of the relative sensitivity of each coil reduces the noise penalty inherent in the previous square root of the sum of the squares of the intensity of each pixel.

The image producing means may be arranged to use relative sensitivity data at lower resolution compared to image data.

The relative sensitivity of each coil may be obtained by dividing the sensitivity of each coil with that of one particular coil, or alternatively the sensitivity of each coil may be divided by the square root of the sum of the squares of the sensitivity of each coil. This may be done on a pixel-by-pixel basis from the images produced by each coil, or a calculation using deconvolution may be done in k-space.

It is advantageous to use the relative sensitivity data at lower resolution compared to the image data. The lower resolution data may be obtained in image space by averaging the intensity of a pixel with that of a group for example a block of adjacent pixels. The block could be a square region including the pixel, for example, 3, 4 or 5 pixels in length. Alternatively, the data may be filtered, or lower resolution may be accomplished in k-space by using the data up to a lower maximum phase-encode gradient.

### DRAWINGS

Magnetic resonance imaging apparatus in accordance with the invention will now be described in detail, by way of example, with reference to the accompanying drawings in which:

FIG. 1 is a schematic axial sectional view of known magnetic resonance imaging apparatus;

FIG. 2 is a plan view of the coil array of the magnetic resonance imaging apparatus of FIG. 1;

FIG. 3 is a side view of the coil array of the magnetic resonance imaging apparatus of FIG. 1;

FIG. 4 is a representation of data in k-space corresponding to each of the coils of the array shown in FIGS. 2 and 3;

FIG. 5 is a representation of the spatial image corresponding to each of the k-space representations of FIG. 4;

FIG. 6 is a representation of the theoretical optimal method for combining the spatial image data from the coils shown in FIG. 5;

FIG. 7 is a representation of the standard sum of squares method for combining the spatial image data from the coils shown in FIG. 5;

FIG. 8 is a representation of the method used in apparatus according to the invention for combining the spatial image data from the coils shown in FIG. 5;

FIG. 9 illustrates the architecture of the signal processing unit of the apparatus according to the invention;

FIG. 10 shows a slice through an object;

FIG. 11 shows a combined image of the slice using the conventional sum of squares method;

FIG. 12 shows a combined image of the slice using outputs of the coils of an array combined as a magnitude image in accordance with the method of the invention;

FIG. 13 shows a combined image of the slice using outputs of the coils of an array combined as the real part of a complex image in accordance with the method of the invention;

FIG. 14 shows an actual combined spatial image which used the standard sum of squares method; and

FIG. 15 shows an actual combined spatial image which used the method of the invention.

Like reference numerals have been given to like parts throughout all the drawings.

### DESCRIPTION

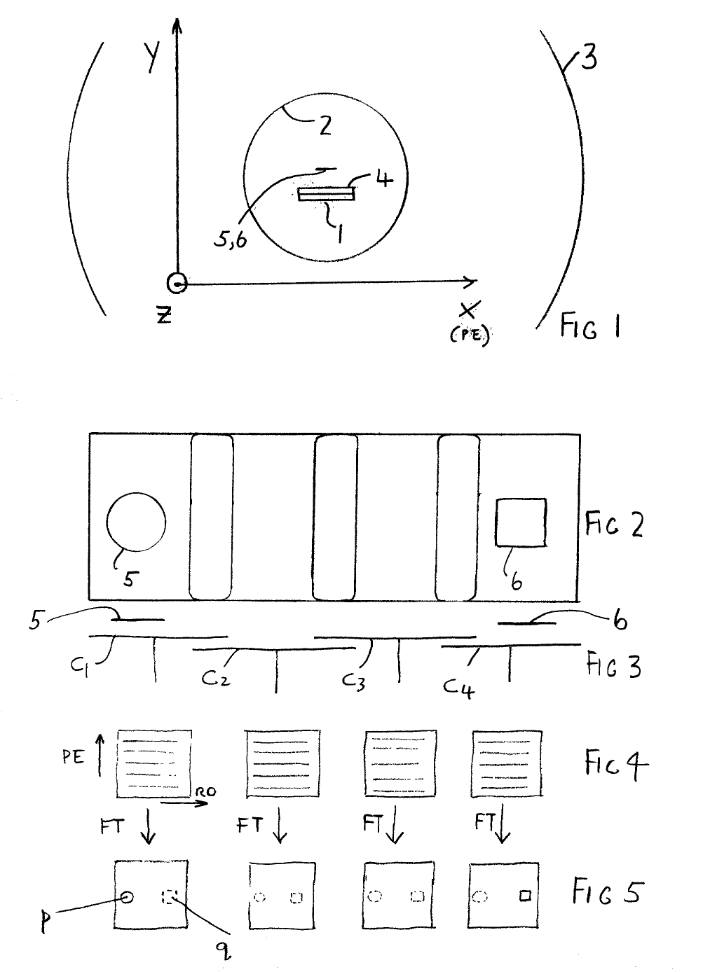

The apparatus for producing the main magnetic field and gradient magnetic fields could be as described with reference to FIGS. 1 to 5. While this discloses a superconducting magnet, the invention is also applicable to resistive electromagnets and permanent magnets for generating the main magnetic field. The coil array 4 is a spine array with four coils, but normally more would be provided. However, the invention is not restricted to any particular configuration or number of coils of the array.

Transmit pulses for excitation of magnetic resonance (MR) active nuclei in an examination region in the main magnetic field may be provided by a separate transmit coil, or by using the coils of the array.

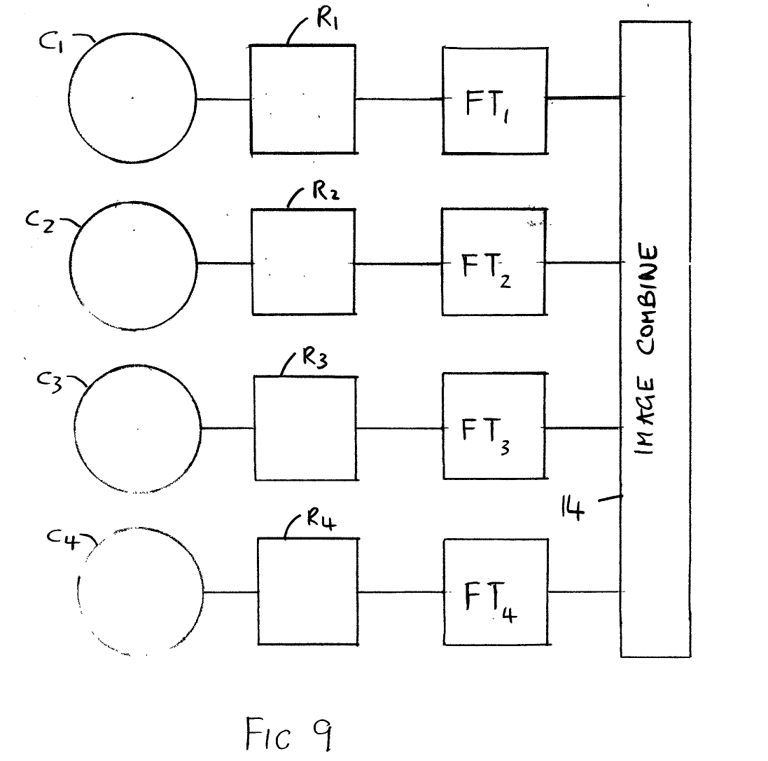

The signal processing unit (FIG. 9) includes a digital R₁, R₂, R₃, R₄ connected to each receive coil C₁-C₄. Each exciting RF pulse produces at least one echo signal received by the coil which is converted to digital form and stored in a matrix in k-space of the form shown in FIG. 4. Each row of k-space corresponds to a different phase-encode gradient.

Each receiver R₁ etc is connected to a respective Fourier transform processor FT₁, FT₂, FT₃, FT₄, which convert the matrices to real space images. These are fed to image combining unit 14, which performs the functions set out in FIG. 8.

Referring to FIG. 8, after a sufficient number of excitations has taken place to build up one complete spatial image from each receive coil, the spatial images are combined according to the invention.

The phase-encode gradients of each k-space matrix of FIG. 4 are spaced by such a distance that the field of view covers the entire region to be imaged.

Thus, box 7a represents a memory storing data representing the intensity in complex form of the spatial image produced by coil C₁, box 8a represents a memory storing data representing the intensity in complex form of the spatial image produced by coil C₂, and so on.

Typically, each matrix storing the spatial image is 256 by 256 pixels.

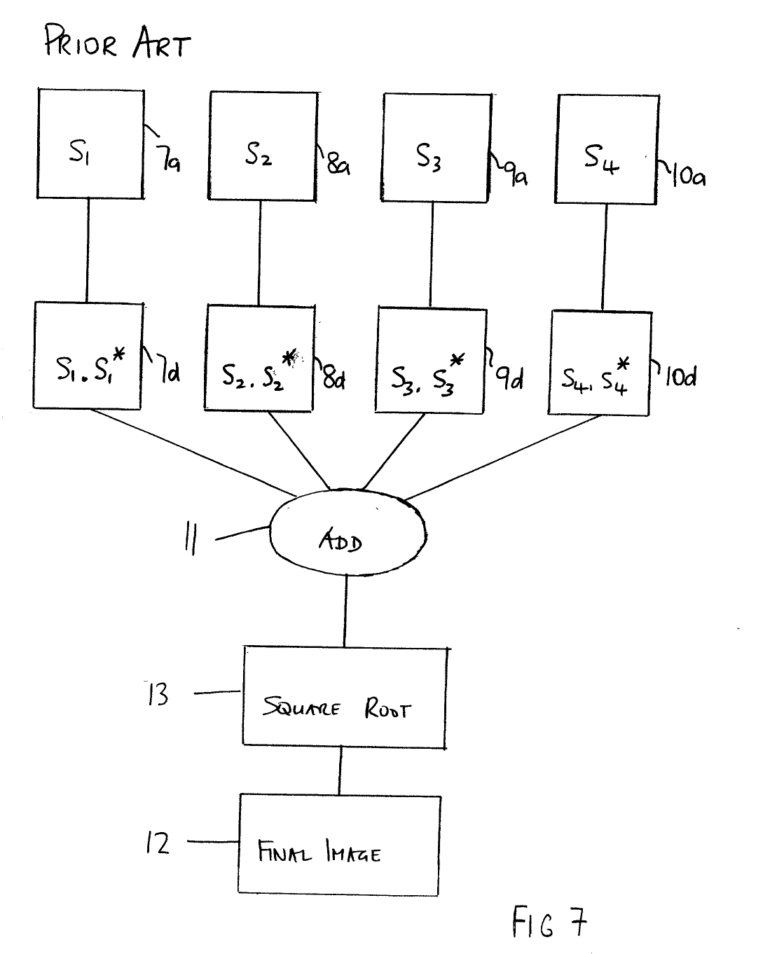

According to the invention, the spatial images in memories 7a-10a are combined, on a pixel-by-pixel basis, by summing the complex product of the intensity of each pixel and the relative sensitivity of the respective coil at that pixel. To take a simple example, consider the spatial images shown in FIG. 5. The sensitivity of coil C₁ to, say, the spatial region in the examination region which is mapped out in the spatial image as pixel p, is much greater than its sensitivity to the spatial region in the examination region which is mapped out in he spatial image as pixel q. This quantity would be required to perform the optimal calculation of Roemer, but this quantity (the absolute sensitivity) is not known.

The relative sensitivity of coil C₁ can however be determined, on a pixel-by-pixel basis, by dividing the intensity of each pixel of the spatial image produced by coil C₁ by that of, say, the square root of the sum of the squares of the intensities of that pixel over the spatial images produced by all the coils C₁-C₄.

Because the object being imaged is the same in each case, this tends to be suppressed, leaving the actual quantity it is desired to calculate, that is, the ratio of the sensitivities of the coils. The ratio thus produced, however, includes noise from the object being imaged in both the denominator and numerator of the ratio. Equally, the ratio of the actual coil sensitivity, as expressed in the intensities of the pixels of the spatial images, can be expected to vary smoothly.

It is for this reason that the combination of the final images uses the relative sensitivity data at a lower resolution. Very little information about coil sensitivity is lost, but noise and image detail are suppressed.

The way in which the lower resolution image is produced is by a filtering, image processing operation. Thus, memories 7e to 10e store smoothed images produced by taking each pixel in the memory 7a, and averaging the intensity over the 32 by 32 block of pixels surrounding it. The processing means for performing this task is not shown. In order to cope with the problem of averaging at the edges of the desired spatially imaged area, the spatial image in the memories 7a-10a is larger than the desired area. In the frequency encode direction, data is oversampled to twice the field of view. In the phase-encode direction, there are periodic boundary conditions, so opposite edges can be joined. The filtering operation is done on an area larger than the desired area. The filtered data is then cropped to the desired area.

From the smoothed images, a square root of the sum of the squares images is calculated and entered into memory 15. That is, this operation is carried out for each pixel in turn of the spatial images in memories 7e-10e.

Memories 7f-10f store the product S₁<S₁>* etc for each pixel of the respective spatial image, where < > denotes an averaged or smoothed value and * denotes a complex conjugate. The processing means is not shown. When these products are added, pixel-by-pixel, and the results placed in memory 11, and this sum divided, on a pixel-by-pixel basis, by the square root of the sum of the squares for that pixel from memory 15, memory 16 contains for each pixel an intensity value of

$$P = \frac{\sum {S}_{i} {⟨ {S}_{i} ⟩}^{*}}{α}$$

where α is a sum of squares of coil sensitivities \sqrt{Σ<Sᵢ>²}, although it could if desired be a single coil sensitivity bⱼ.

This amounts to

P=ΣS₁bᵢ*/α

where α is the sensitivity of one particular coil bⱼ, in terms of the intensity of the spatial image produced, or of the square root of the sum of the squares of the sensitivities over a given number of coils, or any combination of coils that gives an intensity proportional to the image of the object being imaged.

This corresponds with Roemer's optimal combination referred to above, α being a normalising factor.

To produce the final image, it is then merely necessary to take the real part in memory 17 of the stored complex image in memory 16, on a pixel-by-pixel basis, and transfer it to memory 12. Alternatively, the final image can be a magnitude image, that is, for each pixel, the square root of the sum of the squares of the real and imaginary part of each intensity value. Noise is in both real and imaginary channels. When the real part only is taken, the real channel noise has a zero mean. Taking a magnitude combines noise from both channels and rectifies it making a non-zero mean.

As an alternative to the sum of the squares normalising function, memory 15 could, as indicated, contain the spatial image produced by one particular coil, or any combination of coils giving an intensity proportional to the image of the object being imaged.

While image size of 256 by 256 pixels have been indicated, any size may be chosen. Although it has been suggested that the image smoothing be done by averaging a 32×32 pixel block, other sizes of block may be chosen, or other areas over which to average the image. As an alternative to filtering by spatial averaging, the data could be converted to k-space, all higher spatial frequencies then being multiplied by zero, the data then being transformed back to image space. As another alternative, k-space data from the receiver R₁-R₄ using a data set up to a lower maximum phase-encode gradient than that required to produce a field of view corresponding to the region to be imaged, can be separately transformed by Fourier Transform processors to produce the filtered data for memories 7e to 10e.

The signal processing operations are carried out by digital signal processing apparatus in the image combining unit 14. Analogue processing could however be used at least in part if desired.

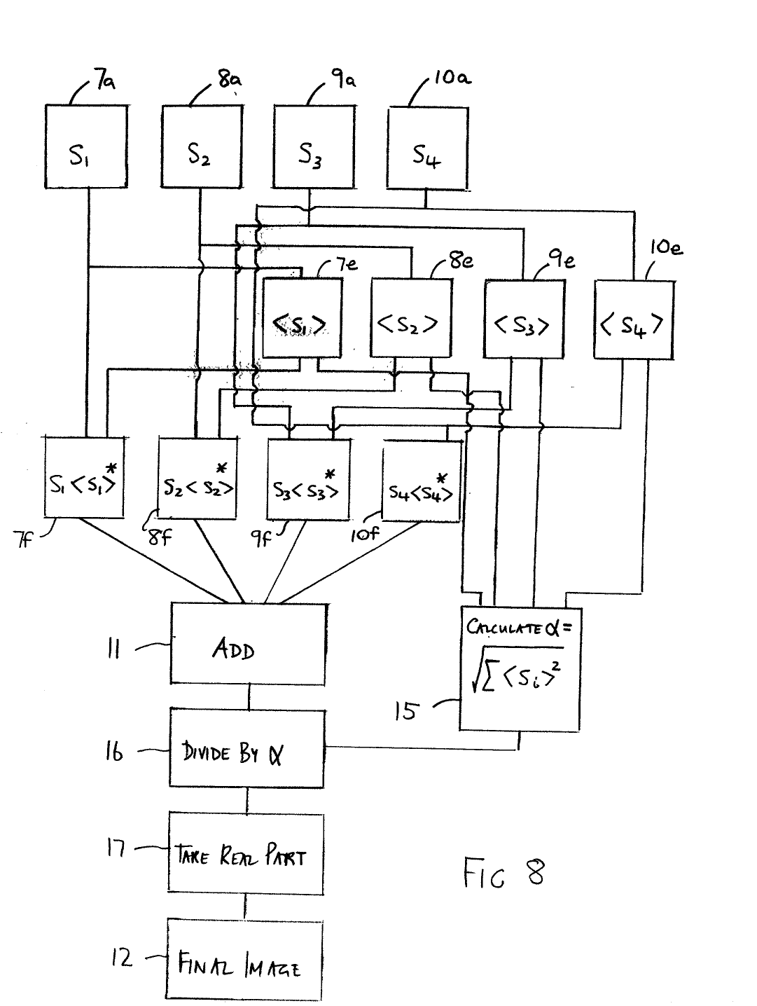

As compared with a final image computed according to the standard method described with reference to FIG. 7, with the method of the invention noise is reduced and can have zero mean, thereby being less likely to obscure the object. Contrast is thus improved. Images of a test object calculated using the standard method, and the method of the invention, are shown in FIGS. 14 and 15 respectively. Such improved contrast could be of course of critical importance since it could form the basis on which a surgeon plans an operation.

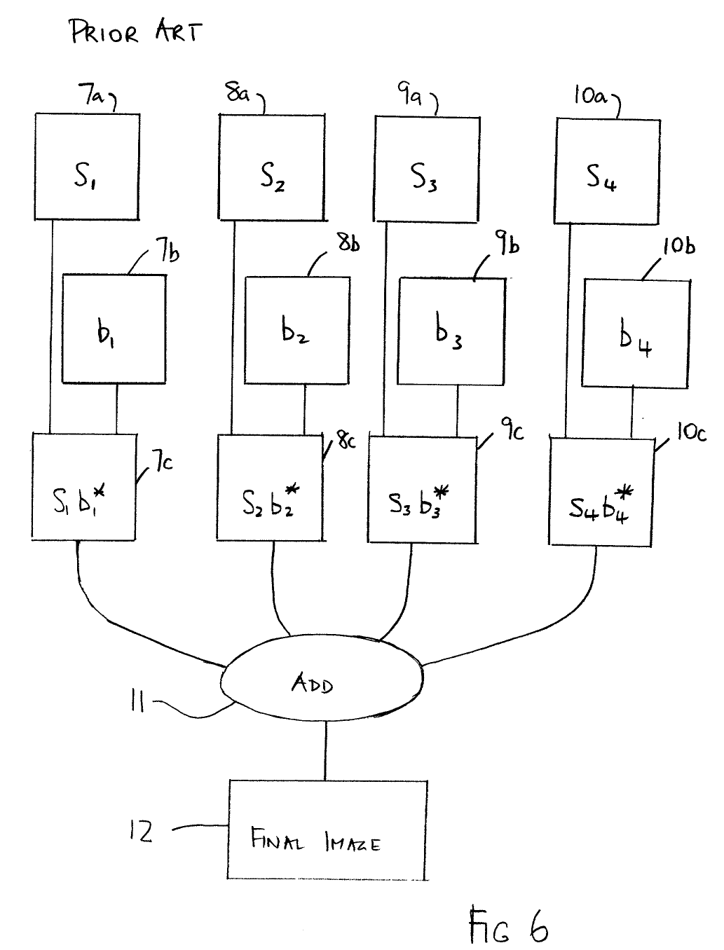

To summarise, the image is produced by combining signals from the array coils C₁-C₄ by using the relative sensitivity of each coil. Thus, for either the array of FIGS. 2 and 3, a standard full field of view image is obtained for each coil. MR signals are received by the coils, suitably encoded by magnetic field gradients, and respective k-space matrices are built up from the signals received by each coil. These are respectively Fourier Transformed to produce real images. The images from the individual coils (the uncombined images) are saved in complex or magnitude form. Estimates are then made of bᵢ/α taking pixel-by-pixel ratios of the uncombined images, where bᵢ is the sensitivity of the i^{th} coil and α is a reference sensitivity, such as a sum of squares of coil sensitivities, or the sensitivity of a single coil bⱼ, or another combination of sensitivities. This divides out information about the subject being imaged, which is common to all uncombined images, leaving a ratio of sensitivities. Now that a sensitivity, in this case a relative sensitivity, is known at each pixel, it is possible to calculate the intensity of each pixel of the resultant image P as follows:

P=ΣSᵢbᵢ*/α

Thus, each pixel of the final image has an optimal signal-to-noise ratio as defined by Roemer. Each sensitivity may be divided by that for one particular coil, which has the effect of setting the sensitivity of the selected coil to unity i.e. normalising it in the calculation of P. Instead of dividing by an individual coil signal, any combination of coils that is linearly proportional to the anatomical signal can be used, for example the square root of the sum of the squares of the coil signals. This would be produced by computing, on a pixel-by-pixel basis the square of intensities of each of the images produced by the coils, summing those squares, and then taking the square root. This gives an image with exactly the same signal properties as the standard sum of squares image, but with improved signal-to-noise ratio. In order to reduce noise in the estimate of bᵢ*/α, the uncombined images can be low pass filtered before division and/or the ratio smoothed after division (although the latter requires more sophisticated filtering). This low pass filtering blurs the anatomical content, but provided the smoothing kernel is small compared to the spatial variations of the coil sensitivity patterns (which usually only vary slowly across the field of view), this has negligible effect on the ratio obtained.

It is to be noted that complex uncombined images appear to be superior to magnitude images where the signal from a coil is not larger than the noise level, because the low pass filtered versions can asymptote to zero with complex (signed) data.

Improved signal-to-noise ratio and reduction of phase-encoded motion artefacts arise where, because a coil has low sensitivity to a given pixel, its contribution is attenuated. Where some of the coils in the array have high local sensitivity patterns, such as with intracavitary coils, the final images can combine all coil information but be presented with a sensitivity profile of only the coils that have slowly varying spatial patterns. For example, if a prostate coil is combined with an external phased array, final images can have signal modulation characteristic of the external phased array, but with locally improved signal-to-noise ratio where the prostate coil has its high sensitivity region. This is easy to view with a dynamic range of a standard display, while retaining the local sensitivity improvement associated with the internal coil.

The particular example given shows four array coils. However, the invention is not limited to any particular number of array coils. Nor is it limited to any particular arrangement of the coils, nor to any particular form of magnet i.e. electromagnet, resistive or superconducting, or permanent, or to any configuration such as solenoidal or open.

In addition, the invention has been described in terms of the processing being carried out in the image domain. However, it may be performed instead in the Fourier domain for either the final signal combination or the calculation of relative coil intensities.

The skilled person will recognise the following as an exposition of the theoretical basis of the invention. As has been explained above, the optimal unbiased way to combined image data from array coils involves a pixel-by-pixel sum of coil signals with each weighted by the individual coil sensitivity at the location of the pixel. A pragmatic alternative combines the images from the coils as the square root of the sum of squares (SOS) which is sub-optimal in that it can reduce signal-to-noise ratio (SNR) and introduce bias, particularly where the local signal-to-noise ratio is low. The following explains how coil sensitivity is replaced by an image derived quantity that enables signal combination in a manner that is close to the optimal up to a global intensity scaling and which may be chosen with some flexibility. Typical global scaling factors include scaling by an individual coil sensitivity or a linear or SOS combination of some or all of the sensitivities of the coils in the array. The proposed method decreases signal bias, can improve SNR where coils have unequal noise levels and can reduce image artefacts. It can produce phase corrected data, which can eliminate bias completely. In addition the method allows images from arrays that include highly localised coils, such as a prostate coil combined with an external pelvic array, to be presented with near-optimal SNR everywhere and with a tailored intensity modulation that makes them easier to view.

At a given pixel location the signal Sᵢ from coil i in an array of n coils is

Sᵢ=ρbᵢ+eᵢ [1]

where ρ is the native NMR signal of interest, bᵢ is the sensitivity of coil i at the pixel in question and eᵢ is the noise output from coil i. Assuming no correlations between the coils, the optimal unbiased estimate (Pₒₚₜ) for ρ is obtained from

$${P}_{opt} = {\sum }_{i} \frac{{S}_{i}}{{b}_{i}} {ω}_{i} \qquad [ 2 ]$$

where the weights ωᵢ are given by

$${ω}_{i} = \frac{{b}_{i}^{2}}{{\sum }_{j} {b}_{j}^{2}} \qquad [ 3 ]$$

where bⱼ is the sensitivity of coilⱼ at the pixel in question. In the case of b_{1,i} can be any number in the range 1−n, in the case of b_{j,j} is a fixed number in the range 1−n.

Thus

$${P}_{opt} = \frac{1}{{\sum }_{j} {b}_{j}^{2}} {\sum }_{i} {S}_{i} {b}_{i}^{*} \qquad [ 4 ]$$

where the asterisk denotes complex conjugation and the convention z²≡z*z is followed. By substitution of Sᵢ, equation [4] can be seen to be ρ plus a weighted noise term,

$${P}_{opt} = ρ + \frac{1}{{\sum }_{j} {b}_{j}^{2}} {\sum }_{i} {e}_{i} {b}_{i}^{*} \qquad [ {4}^{′} ]$$

This gives an unbiased estimate of ρ. However, if ρ has spatially varying phase, a magnitude presentation (|ρ|) will often be preferred and this may introduce bias due to rectification of negative noise contribution.

Roemer concluded that since the bᵢ are not usually known for each pixel in an in vivo examination an alternative to [4] must be adopted in practice. This is the SOS combination, which was introduced in an ad hoc manner, but which may be derived explicitly using an estimate of the coil sensitivity (bᵢ′) of the form

$${b}_{i}^{′} = \frac{{S}_{i}}{α} \qquad [ 5 ]$$

with

$$α = \sqrt{{\sum }_{k} {S}_{k}^{2}} .$$

Substituting bᵢ′ from equation [5] for bᵢ in equation [4] gives the expected result,

$${P}_{sos} = \sqrt{{\sum }_{k} {S}_{k}^{2}} \qquad [ 6 ]$$

Obviously P_{SOS} is modulated by the SOS of the coil sensitivities, which can be a disadvantage if this is a strongly varying function of position.

Partially parallel imaging also requires values for bᵢ to unfold sub-encoded data. It has become common practice to estimate bᵢ by acquiring a low resolution fully phase-encoded image in the target imaging plane and eliminating signal dependence on ρ by dividing by a separate image acquired with another coil (such as whole body coil) (6) or some combination of signals from the coils in the array (11, 12). Thus

$${b}_{i}^{′} = \frac{⟨ {S}_{i} ⟩}{⟨ α ⟩} \qquad [ 7 ]$$

where < > indicates that the data is at lower resolution. Common choices are <α>=<Sₖ> if one coil (k) in the array is used,

$$⟨ α ⟩ = {\sum }_{k} {a}_{k} ⟨ {S}_{k} ⟩$$

for a weighted sum or

$$⟨ α ⟩ = \sqrt{{\sum }_{k} {⟨ {S}_{k} ⟩}^{2}}$$

for the SOS combination. Note that the latter choice causes <α> to be proportional to the modulus of the NMR signal whereas the others also contain phase information.

This low resolution approach for estimating bᵢ may be combined with non-parallel imaging acquisitions, in which a whole data-set is available. The low resolution data may then obtained directly from the high resolution data itself by applying a smoothing filter. Because the bᵢ generally vary slowly across the imaging volume, substantial smoothing kernels can be employed without significantly distorting the underlying sensitivity profiles. The object being imaged (ρ) usually has fine detail, which is blurred by this process (<ρ>), but since it is to be divided out anyway this is of no consequence. Experience from the current study and numerous parallel imaging reports indicates that quite significantly lower resolution data may be used. Additional smoothing or curve fitting procedures may be applied after the ratio has been obtained.

Substituting bᵢ′ from equation [7] for bᵢ in equation [4] gives

$${P}_{α} = \frac{⟨ α ⟩}{{\sum }_{j} {⟨ {S}_{j} ⟩}^{2}} {\sum }_{i} {S}_{i} {⟨ {S}_{i} ⟩}^{*} \qquad [ 8 ]$$

Now making three assumptions: (1) that smoothing reduces the noise in Sᵢ to a negligible level, (2) that the underlying coil profiles are preserved through the smoothing (as discussed above) and (3) that systematic errors such as motion artefact are absent from Sᵢ, equation [8] may be simplified as follows. Choosing <α> to be each coil modulation in turn, <α>=<Sₖ>, one obtains for coil k

$${P}_{k}^{′} = \frac{{b}_{k}}{{\sum }_{j} {b}_{j}^{2}} {\sum }_{i} {S}_{i} {b}_{i}^{*} \qquad [ 9 ]$$

which by comparison with equation [4] can be seen to be bₖPₒₚₜ, i.e. the optimal reconstruction modulated by coil k. Making a SOS combination of the Pₖ gives

$${P}_{sos}^{′} = \sqrt{{\sum }_{k} {b}_{k}^{2}} \vert {P}_{opt} \vert \qquad [ 10 ]$$

To see what has been achieved by this construction in comparison with the conventional SOS we calculate the difference, δ=P_{SOS}−P_{SOS}′, which for

$$\vert {\sum }_{i} ρ {b}_{i} \vert >> \vert {\sum }_{i} {e}_{i} \vert$$

is

$$δ \approx \frac{{\sum }_{i , j}^{i < j} {( {b}_{i} {e}_{j} - {b}_{j} {e}_{i} )}^{2}}{2 {\sum }_{k} {b}_{k}^{2}} \cdot \frac{1}{\sqrt{{\sum }_{k} {b}_{k}^{2}} \vert ρ \vert} \qquad [ 11 ]$$

Note that δ is always ≧0 and therefore P_{SOS} is always ≧P_{SOS}′. This positive difference reflects a bias in the estimate of ρ, the magnitude of which depends on the noise level and varies inversely with |ρ|.

The simple difference, equation [11], is useful in that it shows for a particular image what has been gained by using equation [7] instead of equation [5] to estimate the relative coil sensitivities. It can be helpful conceptually to separate δ into the product of two terms: one that establishes the overall magnitude of the bias

$$( β = ( {\sum }_{i , j}^{i < j} {( {b}_{i} {e}_{j} - {b}_{j} {e}_{i} )}^{2} ) / 2 {\sum }_{k} {b}_{k}^{2} )$$

and one that gives object-related structure to the bias

$$( ξ = {( \sqrt{{\sum }_{k} {b}_{k}^{2}} \vert ρ \vert )}^{- 1} ) .$$

Whereas ξ reflects an intrinsic property of the image, namely the product of the object and the coil modulation, β is increased or decreased by the processing applied. In addition β=(P_{SOS}²−P_{SOS}′²)/2 is experimentally measurable and so allows the validity of the model to be tested. Since β reflects only the noise-related bias, any residual object structure indicates a breakdown in the model.

Now if instead of considering individual signal measurements, an ensemble is evaluated, the cross terms in β average to zero and it becomes

$$\overline{β} = \frac{{\sum }_{i , j}^{i < j} {b}_{i}^{2} {e}_{j}^{2}}{2 {\sum }_{k} {b}_{k}^{2}} \qquad [ 12 ]$$

This may be used in equation [11] to calculated the ensemble difference,

\overline{δ}=\overline{β}ξ [13]

When all n coils contribute the same noise \overline{β} becomes (n−1)\overline{e²}/2, where \overline{e²} is the ensemble average of (Re(e)²+Im(e)²). Given that the variance of the noise (σ²) is equal in both real and imaginary channels, the ensemble average \overline{e²} is just 2σ². Thus \overline{β}=(n−1)σ² and is constant over the whole image. As it stands, \overline{δ} has the same units as the signal and depends on the variance of the noise. We can construct a dimensionless normalized measure of the bias \tilde{δ}=\overline{β}ξ², which is related to another measurable quantity, the signal-to-noise ratio (SNR),

$$\tilde{δ} = \frac{( n - 1 )}{{SNR}^{2}} \qquad [ 14 ]$$

The SOS bias, \tilde{δ}, provides a measure of the improvement obtained in performing an optimal signal combination rather than a conventional SOS. The degree of improvement is inversely related to the local SNR and increases with the number of coils used. Therefore the conventional SOS overestimates the signal by a margin that increases as the signal decreases. This reduces differences between high and low signal regions within an image, resulting in a decrease in the image contrast.

An alternative method for obtaining a reduced bias image is to use |<α>| in equation [8]. As before, for an individual coil modulated reconstruction we let <α>=<Sₖ> which leads to

Pₖ″=|bₖ|<\hat{ρ}*>Pₒₚₜ [15]

and for the SOS

$${P}_{sos}^{″} = \sqrt{{\sum }_{i} {b}_{i}^{2}} ⟨ {\hat{ρ}}^{*} ⟩ {P}_{opt} \qquad [ 16 ]$$

where <\hat{ρ}*> is the conjugate phase of the low resolution representation of the object. This equation is comparable to [10] except that Pₒₚₜ appears explicitly in its full form. If the phase structure in the object (such as due to susceptibility effects with a field echo acquisition) is preserved after the smoothing, then <\hat{ρ}*>ρ≡|ρ| and equation [16] becomes

$${P}_{sos}^{″} = \sqrt{{\sum }_{k} {b}_{k}^{2}} \{ \vert ρ \vert + \frac{⟨ {\hat{ρ}}^{*} ⟩}{{\sum }_{j} {b}_{j}^{2}} {\sum }_{i} {e}_{i} {b}_{i}^{*} \} \qquad [ 17 ]$$

In this equation, the signal of interest is contained entirely in the real component whilst noise is distributed over both real and imaginary components. Hence the real part may be chosen to eliminate the noise in the imaginary channel. If the magnitude is taken then |P_{SOS}″| becomes identical with P_{SOS}′ of equation [10], but since we only require |ρ| we can just take Re{P_{SOS}″}, and if desired set any negative values to zero. The result is the real part of a SOS modulated phase-corrected Pₒₚₜ, for which \overline{β}=(n−1/2)σ² and

$$\tilde{δ} = \frac{( n - 1 / 2 )}{{SNR}^{2}} \qquad [ 18 ]$$

In each of the cases above, P_{α} is obtained, in accordance with the invention, by a process of Summation Using Profiles Estimated from Ratios (SUPER). It is clear that the <α> used to convert received signal to an estimate of coil sensitivity must be proportional to <ρ> but is otherwise unconstrained and can be chosen to suit the application at hand. This freedom of choice over <α> is convenient if part of the array consists of coils with highly localised sensitivity profiles. An example is the combination of a small intracavitary coil placed adjacent to the prostate with an external surface coil. The conventional SOS image suffers in two ways: (1) its intensity is highly non-uniform because of the contribution from the prostate coil and (2) in the region of high sensitivity of the prostate coil the external coil, which is larger and further away, contributes more noise but less signal than the prostate coil so that it lowers the SNR. By calculating <α> from the external coil alone, a SUPER image is obtained that has more uniform intensity in the region of the prostate combined with SNR that is optimal at all locations. Alternatively, a linear sum of the individual coil modulated images

$${\sum }_{k} {a}_{k} \vert {P}_{k}^{′} \vert$$

or

$${\sum }_{k} {a}_{k} Re \{ {P}_{k}^{″} \}$$

may be used that gives the least intensity variation over the image as a whole.

### EXAMPLE

Simulations were performed by generating one dimensional pure real object profiles (ρ) multiplied by Gaussian coil sensitivity profiles (bᵢ) to which were added various levels of noise (eᵢ). The noise was Gaussian random with a mean of zero and standard deviation (σ) of SNR⁻¹, and was added independently to both the real and imaginary channels. The resulting signals were processed by calculating the optimal signal combination (Pₒₚₜ), conventional SOS (P_{SOS}), SUPER (P_{SOS}′) and real-SUPER (Re{P_{SOS}″}) profiles. For the purposes of comparison, Pₒₚₜ was multiplied by the SOS intensity

$$\sqrt{{\sum }_{k} {b}_{k}^{2}} .$$

Experimental data was acquired on a 0.5 T Apollo system (Marconi Medical Systems, Cleveland, Ohio) using array coils for the spine (4 coils, linear geometry) and the prostate (intracavitary prostate coil combined with an external surface coil). All receive coils were actively decoupled during body coil transmit. Fast spin echo sequences were used throughout with data from each coil Fourier transformed to produce separate images, which were stored as complex data. Phantoms were imaged with a TR of 200 msec and TE_{eff} of 20 msec, a 25 cm field of view (FoV) and 256×256 matrix. For imaging the spine TR was 400 msec and TE_{eff} was 12.4 msec with a 58 cm FoV and 256×256 matrix. The prostate images were obtained with TR 593 msec, TE_{eff} 20 msec, FoV 16 cm and 192×256 matrix.

Simulations and data processing were performed on a separate workstation (DEC Alpha running UNIX) using IDL 5.4 (Research Systems, Boulder, Colo.). All smoothing was performed by Fourier domain truncation (256×256 matrix to 32×32) followed by application of a Hanning window to the remaining data. For the 1D simulations, 256×1 matrices were truncated to 32×1, followed by application of a Hanning window.

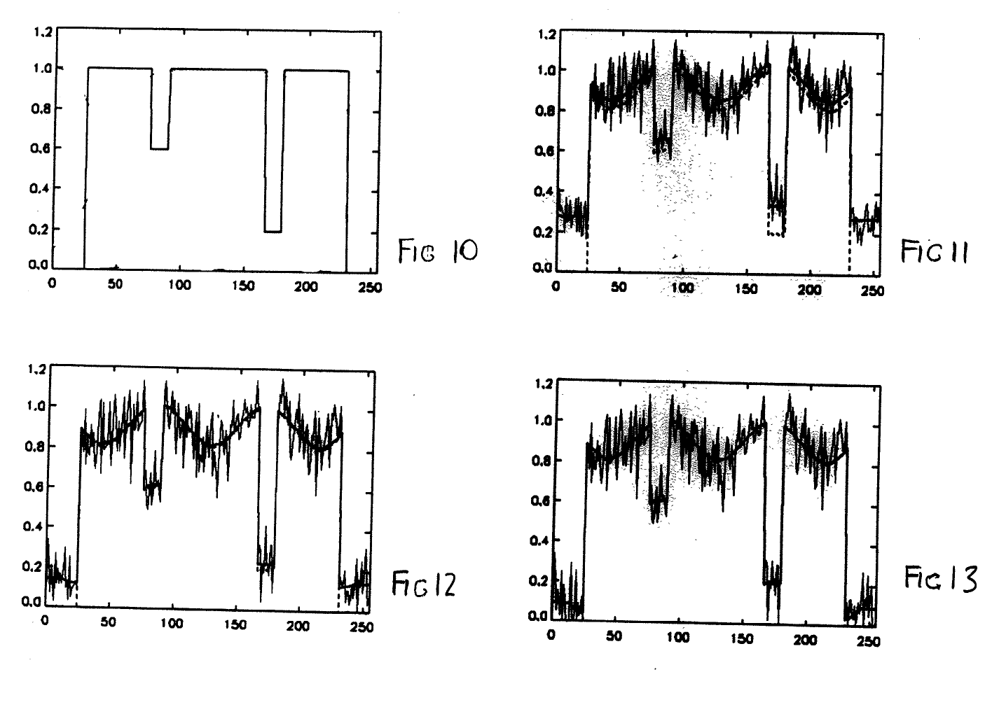

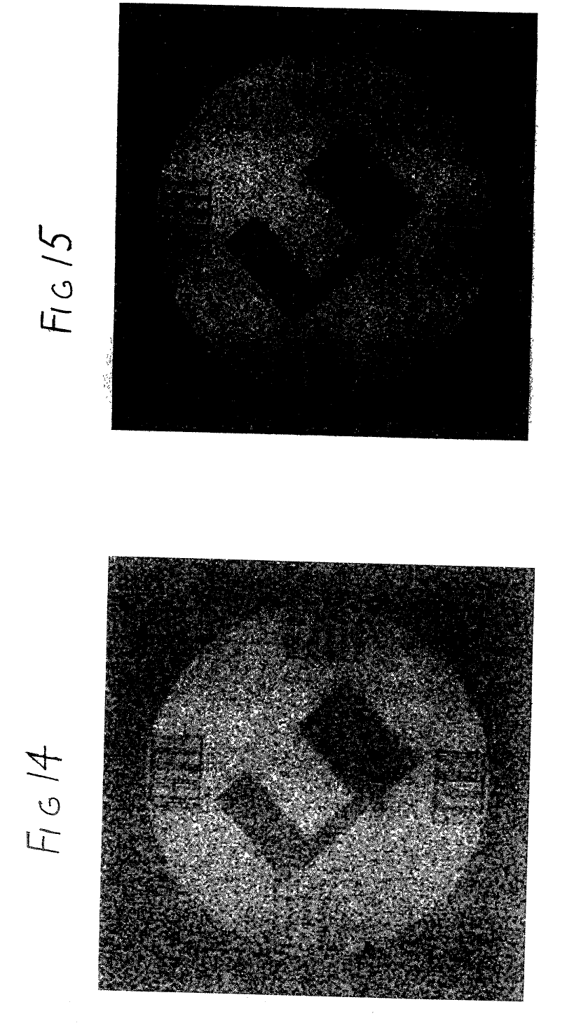

Simulated results for 1000 independent trials of a simple object using 4 coils were obtained, as shown in FIG. 10. Unless otherwise stated the SNR was 10. As may be seen from FIGS. (11-13) the object is reproduced in all combinations modulated by the SOS of the coil profiles. However, there are differences particularly in regions where the signal is low. In each of the Figures the mean signal is shown, revealing the progressive decrease in bias from Pₒₚₜ (FIG. 10) of P_{SOS} (FIG. 11), P_{SOS}′ (FIG. 12) and Re{P_{SOS}″} (FIG. 13), which is the best. Note that, as expected, the error is greater in low signal regions thereby reducing the contrast.

In one experimental implementation, the method was implemented using IDL (Research Systems, Boulder, Colo.) for simulations and experimental data from phased array coils operating at 0.5 T on a Marconi Medical Systems Apollo scanner. The SUPER method was found to eliminate bias in P_{SOS}, leading to improvements in contrast to noise ratio and reduction of background noise signals (FIGS. 14 and 15). It was also found to be effective when the individual coil data was saved as magnitude images before signal combination.

FIGS. 14 and 15 show conventional SOS and SUPER (respectively), reconstructions of the same complex uncombined images from a four coil array, presented with identical window and level settings. The measured standard deviation within homogeneous regions of the object is the same (indicating no change in noise level). Signal bias causes the mean signal in (FIG. 14) to be 18% larger than in (FIG. 15) so that the apparent SNR in the object is increased, but contrast is greatly decreased by an even larger signal bias in low signal regions.

The proposed method eliminates signal bias, which increases contrast to noise ratio and makes quantitative measurement using array coils more accurate. It can also improve SNR where coils have unequal noise levels and reduce image artefacts. The pixel-by-pixel signal addition using the SUPER method according to the invention allows the benefits of optimal signal combination for array coil data to be achieved by estimating the coil sensitivity as a ratio directly from the data itself. No extra data is required so the only cost is computer processing time, which is typically a few seconds for 4 coil, 256×256 pixel images using software written in IDL.

The two key steps required to produce best results in the method of the invention are (1) the recognition that although Roemer's original formalism involved absolute coil sensitivities, in fact only relative sensitivities are required; and (2) the use of smoothing to reduce noise fluctuations in the coil sensitivity estimates. These lead to an improvement over the conventional SOS approach since random errors in the estimation of the coil sensitivity can be smoothed away, leaving only one contribution from the noise in the final image. The result is a reduction or removal of intensity bias in the image and under some circumstances a reduction in noise levels.

The SUPER method, as with the SOS, works effectively with either complex or magnitude input data, although some of the bias and SNR improvement is lost in the latter case due to rectification of noise in the input data. This has the advantage that images stored as magnitude data can be retrospectively combined as SUPER images.

Finally it is worth noting that, although the (SUPER) method according to the invention has been presented as an image domain approach, the same results can be obtained by a k-space (9) using a generalisation of SMASH (Sodickson D K and Manning W J. Simultaneous acquisition of spatial harmonics (SMASH): ultra-fast imaging with radiofrequency coil arrays. Magn Reson Med 1997; 38: 591-603). The use of low resolution in situ reference data to estimate relative coil sensitivities is the link between SUPER and partially parallel imaging. Of course, if reduced phase-encode acquisitions are employed the data cannot be its own reference, and a low-resolution full data set may be used as reference data. This is an integral part of parallel imaging and represents a powerful capability of optimal signal combination with scope for increased acquisition speed. The SUPER method unifies this with conventional array coil imaging, establishing a common methodology with common benefits.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. Magnetic resonance imaging apparatus comprising means for exciting magnetic resonant (MR) active nuclei in a region of interest, means for creating magnetic field gradients in a phase-encode direction for spatially encoding the excited MR active nuclei, the number of phase-encode gradients producing a field of view corresponding to the region of interest, an array of at least two r.f. receive coils for receiving data from the region of interest, and means for producing an image by combining signals from the coils of the array, using the relative sensitivity of each coil.

2. Magnetic resonance imaging apparatus as claimed in claim 1, wherein the image producing means is arranged to use relative sensitivity data at lower resolution compared to image data.

3. Magnetic resonance imaging apparatus as claimed in claim 2, in which the lower resolution data is obtained in use in image space.

4. Magnetic resonance imaging apparatus as claimed in claim 3, in which the lower resolution data is obtained in use by averaging the intensity of each pixel of an image produced by a coil over a group of pixels.

5. Magnetic resonance imaging apparatus as claimed in claim 2, in which the lower resolution data is obtained in use in k-space.

6. Magnetic resonance imaging apparatus as claimed in claim 5, in which the lower resolution data is obtained in use by using data corresponding to lower maximum phase-encoding gradient than that used to image the data.

7. Magnetic resonance imaging apparatus as claimed in any one of claims 2 to 6, in which the relative sensitivity data is low pass filtered.

8. Magnetic resonance imaging apparatus as claimed in any one of claims 1 to 7, wherein the relative sensitivity of each coil is a measure of the relative intensity of each pixel of the spatial image produced by that coil.

9. Magnetic resonance imaging apparatus as claimed in claim 8, wherein the image producing means is arranged to sum, for each pixel of the final image, the product of the intensity of that pixel and the relative sensitivity of the respective coil at that pixel, over all the coils.

10. Magnetic resonance imaging apparatus as claimed in any one of claims 1 to 9, wherein the image producing means is arranged to produce the relative sensitivity of each coil in image space by dividing the intensity of the spatial image from each coil by the intensity of a spatial image derived from at least one other coil, on a pixel-by-pixel basis.

11. Magnetic resonance imaging apparatus as claimed in claim 10, in which the division is relative to the intensity of the image obtained by one particular coil of the array.

12. Magnetic resonance imaging apparatus as claimed in claim 10, in which the division is relative to the square root of the sum of the squares of the intensities of the images produced by all the coils of the array.

13. Magnetic resonance imaging apparatus as claimed in claim 1, in which the relative sensitivity is calculated in k-space.

14. A method of magnetic resonance imaging comprising exciting magnetic resonant (MR) active nuclei in a region of interest, creating magnetic field gradients in a phase-encode direction for spatially encoding the excited MR active nuclei, the number of phase-encode gradients producing a field of view corresponding to the region of interest, receiving r.f. data from the region of interest using an array of at least two r.f. receive coils, and producing an image by combining signals from the coils of the array using the relative sensitivity of each coil.
